(19) United States
(12) Patent Application Publication
(10) Pub. No.: US 2007/0146646 A1
(43) Pub. Date: Jun. 28, 2007

(54) DIGITAL ANNOTATION SYSTEM AND METHOD

(75) Inventor: Ernesto M. Rodriguez JR., Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/614,128

(22) Filed: Dec. 21, 2006

Related U.S. Application Data
(60) Provisional application No. 60/754,264, filed on Dec. 28, 2005.

(51) Int. Cl. G03B 21/14

(52) U.S. Cl. 353/69

(57) ABSTRACT

The present invention described herein features a digital annotation system, a digital annotation system incorporated in a projection device, and a method for providing digital annotation. A video processing chip includes a central processing unit configured to provide video processing and digital annotation.

### CROSS REFERENCE TO RELATED APPLICATION

This application claims the benefit of U.S. Provisional Patent Application No. 60/754,264, filed Dec. 28, 2005, the disclosure of which is incorporated by reference herein in its entirety.

### TECHNICAL FIELD

The present invention relates generally to a digital annotation system. More particularly, the invention relates to a digital annotation system incorporated in a projection device. In addition, the present invention relates to a method for providing digital annotation.

### BACKGROUND

The use of an interactive display board, such as an interactive whiteboard, for example, for digital annotation, is known. An interactive whiteboard having digital annotation capability is typically a writing surface, such as a dry-erase whiteboard, which can capture writing electronically. Some interactive whiteboards also allow interaction with a projected computer image. These products are often used in a business or classroom setting and are useful in many applications that enable sharing and working with information. For example, digital annotation can be used in combination with an interactive display board to capture and save notes or feedback, or to highlight or underline important aspects during a presentation.

In today's marketplace, digital annotation solutions require that special annotation software be loaded on the user's personal computer for direct communication and usage. Thus, the computer loaded with the special annotation software becomes a required element of the system, at least in part because the annotation software is very complicated and must run off the PC due to the processing speed that conventional software requires. This annotation software also usually requires a digital pen or other device for interacting with the interactive display board. In addition, a connection from the user's personal computer (PC) to the interactive display board is required to run the annotation operations from the PC.

### SUMMARY OF THE INVENTION

The present invention described herein features a digital annotation system and a method for providing digital annotation.

In one aspect of the invention, a video processing chip comprises a central processing unit configured to provide video processing and digital annotation.

In another aspect, a digital annotation system includes a projection screen, a projection device, and a video processing chip configured to provide video processing and digital annotation. The video processing chip can be embedded in the projection screen or it can be embedded in the projection device. The projection device can be a front projection device or a rear projection device. The system can further include an annotation input device, such as a stylus. The system can allow a user to perform one or more of the following digital annotation operations: underlining, highlighting, drawing, writing, erasing, selecting a color, and selecting a blank page.

In another aspect, a method of providing digital annotation includes embedding digital annotation software into a video processing board comprising a video processing chip and its associated memory. The digital annotation software performs the following steps: activating the digital annotation function; providing a menu of digital annotation operations; detecting the digital annotation made by a user; capturing the digital annotation made by the user; storing the digital annotation made by the user; and copying the digital annotation to a memory device.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

FIG. 1 is an isometric view of an exemplary embodiment of a digital annotation system according to the present invention.

FIG. 2 is an exemplary digital annotation controller board.

FIG. 3 is an isometric view of another exemplary embodiment of a digital annotation system according to the present invention.

FIG. 4 is an isometric view of another exemplary embodiment of a digital annotation system according to the present invention.

FIG. 5 is an isometric view of another exemplary embodiment of a digital annotation system according to the present invention.

These figures are not drawn to scale and are intended only for illustrative purposes. While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized and structural or logical changes may be made without departing from the scope of the present invention. The following detailed description, therefore, is not to be taken in a limiting sense, and the scope of the invention is defined by the appended claims.

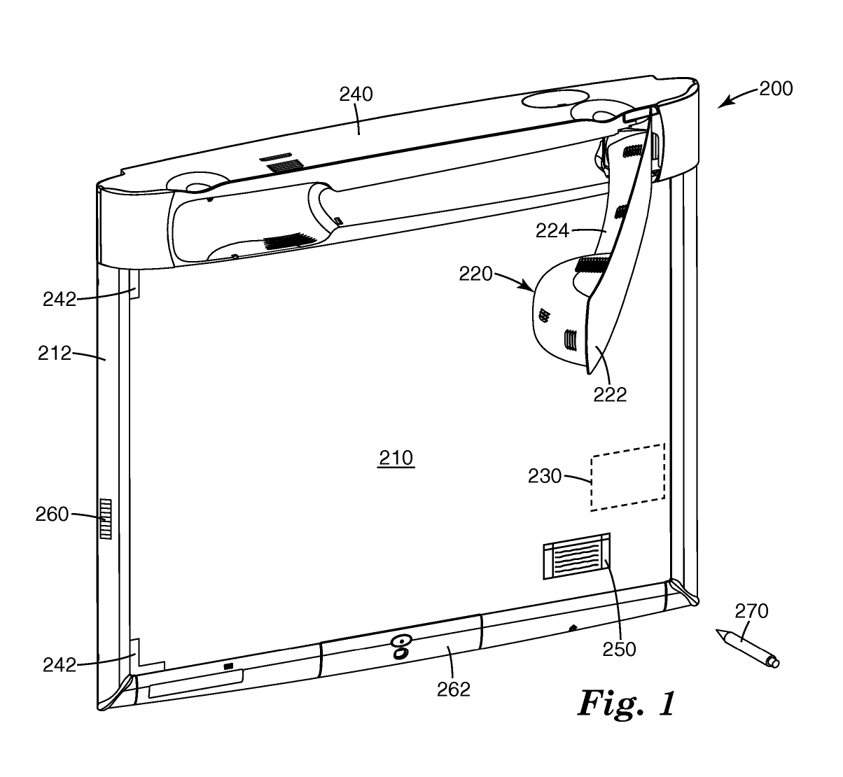

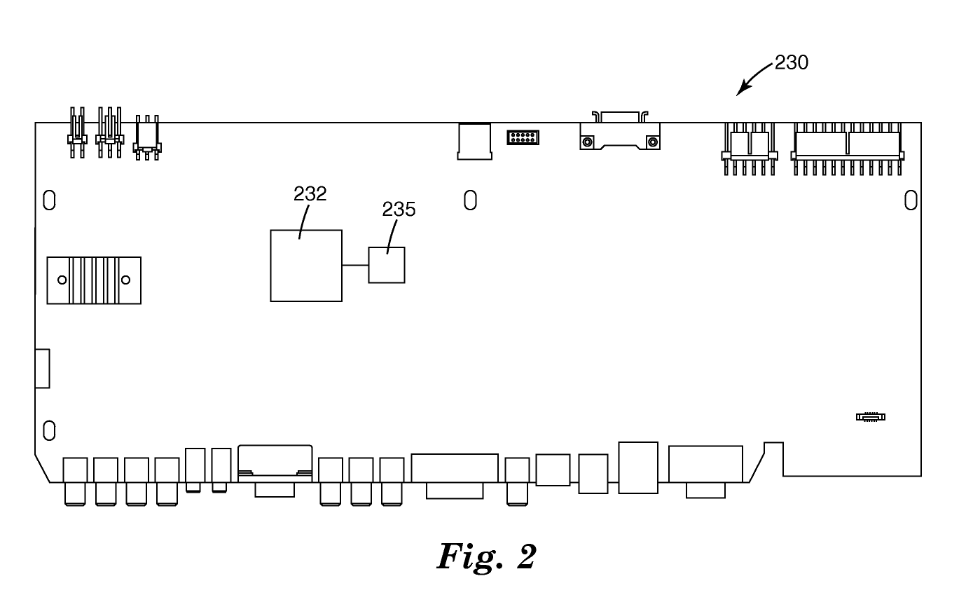

Referring now to the drawings, an exemplary embodiment of the present invention is illustrated in FIG. 1, a digital annotation system 200. System 200 includes a screen or projection surface 210, a projection device 220; and a controller board 230 having a video processing chip configured to provide digital annotation. Digital annotation software, such as described in more detail below, is fully embedded on video processing chip 232 (FIG. 2), thus providing video processing along with the capability for a user to capture and digitally save annotations made on screen 210, without needing a separate personal computer to capture and digitally save those annotations.

Viewing surface or screen 210 can be constructed as a digital whiteboard, similar to that described in U.S. Pat. No. 6,179,426, incorporated by reference in its entirety. For example, the screen 210 may include multiple-layers or special coatings, such as to allow its use as an erasable whiteboard. The frame 212 can contain and support other components of the system. The frame 212 may house additional components, such as integrated speakers (not shown), input/output port 260, and a control panel 262. In the present exemplary embodiment, the mechanical infrastructure of the projection screen frame can include lightweight materials such as aluminum, magnesium, or plastic composites.

Projection device 220 includes a projection head 222 that is configured to project an image onto screen 210. Optionally, the generated image can be viewed on any surface, e.g., a wall or other structure, or standard viewing screen. Projection head 222 can include an optical engine having one or more of the following components: an illumination system, an imaging system, a focus mechanism, and projection optics. As shown in this exemplary embodiment, the projection head 222 can be moved via a moveable arm 224. The arm, when not in use, can be optionally housed in a housing 240, which can be structurally integrated with or can be provided separate from frame 212. In a further alternative, the optical engine can also be housed within the frame 212, for use in a rear projection device.

Exemplary configurations for projection device 220 are described in U.S. Patent Publication No. 2005-0157402 and U.S. Pat. No. 7,123,426, each of which is incorporated by reference in its entirety.

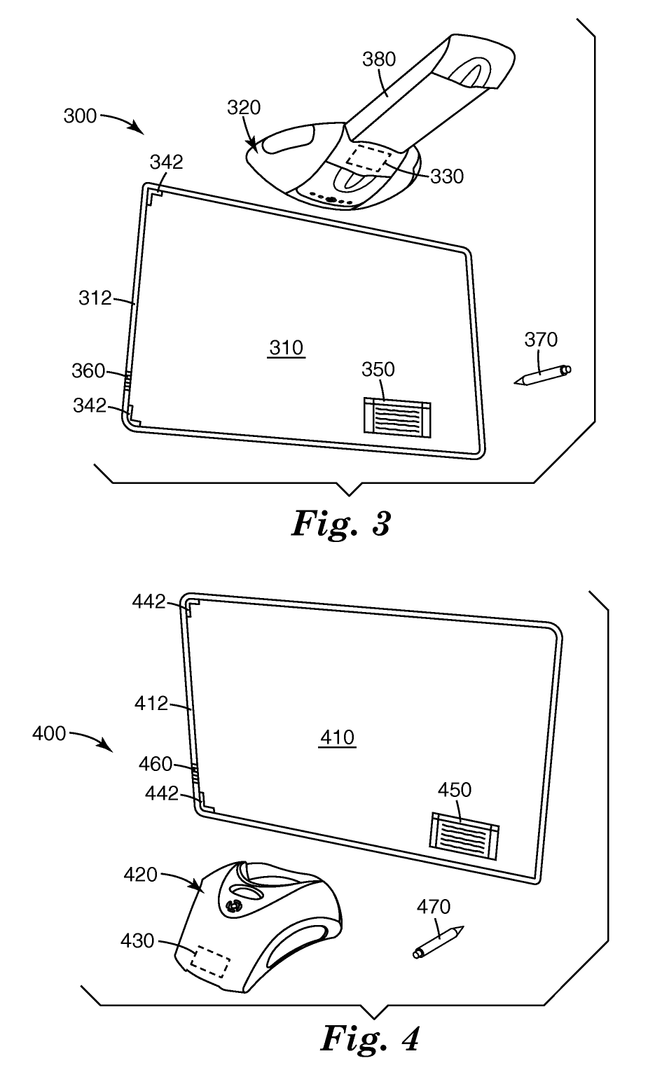

FIG. 3 illustrates another exemplary embodiment of the present invention. A digital annotation system 300 includes a screen or projection surface 310, a projection device 320, and a controller board 330 having a video processing chip configured to provide digital annotation. In this embodiment, controller board 330 is positioned in projection device 320. Projection device 320 is a wall mount unit that may have an open position (as shown in FIG. 3) and a closed position (not shown). In use, an operator can activate the imaging unit to one or more set screen sizes. Moveable tray 380 can then be activated and positions the optical engine at a set distance from the screen corresponding to the image size selected. Focusing can be performed manually by the operator, through the use of a remote control device, or automatically with a conventional auto-focus mechanism. Screen or projection surface 310 includes frame 312, which may house input/output port 360. Optionally, system 300 may further include input device 370, menu 350 displayed on screen 310, and a sensor system including ultrasound, IR laser, charge-coupled device (CCD) cameras, or other types of sensors 342.

Another exemplary embodiment of the present invention is illustrated in FIG. 4. A digital annotation system 400 includes a screen or projection surface 410, a projection device 420, and a controller board 430 having a video processing chip configured to provide digital annotation. In this embodiment, controller board 430 is positioned in projection device 420. Projection device 420 is a portable projection unit that houses an optical engine in a compact, portable structure. The portable unit 420 can be placed on a table top surface a short distance from screen or projection surface 410. Screen or projection surface 410 includes frame 412, which may house input/output port 460. Optionally, system 400 may further include input device 470, menu 450 displayed on screen 410, and a sensor system including ultrasound, IR laser, charge-coupled device (CCD) cameras, or other types of sensors 442.

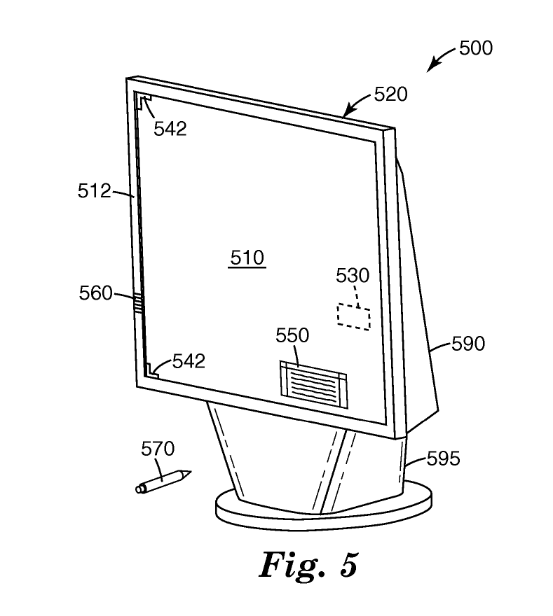

FIG. 5 illustrates another exemplary embodiment of the present invention. A digital annotation system 500 includes a screen or projection surface 510, a projection device 520, and a controller board 530 having a video processing chip configured to provide digital annotation. In this embodiment, controller board 530 is positioned in projection device 520. Projection device 520 is a rear projection display system that includes a base 595, a cabinet 590, and a screen or projection surface 510. Base 595 can house components such as an optical engine, as well as a power supply, control electronics, audio components, and a connector panel (not shown for simplicity), one or more of which can be coupled to the optical engine. Screen or projection surface 510 includes frame 512, which may house input/output port 560. Optionally, system 500 may further include input device 570, menu 550 displayed on screen 510, and a sensor system including ultrasound, IR laser, charge-coupled device (CCD) cameras, or other types of sensors 542.

A conventional video processor chip, such as the sxT2 chip (also known as a Realta T2 chip) from Silicon Optix (San Jose, Calif.), can be utilized as chip 232. The video chip 232 is part of a video processing board 230, such as shown in FIG. 2, which can be located internal to the display board or screen 210. Alternatively, the video processing chip 232 can be embedded in the projection device 220. Software, such as described below, is embedded into video chip 232. The chip 232 can include a 250 MHz 10-bit processor which provides multiple usage for integrating digital annotation software and for controlling various associated hardware providing the digital annotation. For example, an sxT2 chip 232 can provide 2D graphics and real time animation. Chip 232 can also include sufficient memory (either physically located on chip 232 or provided separately on memory chip(s) 235 on processor board 230) and processing capability. Thus, the digital annotation operations are resident to the viewing screen 210 of projection device 220, and can be implemented without the need to couple to a PC having special software loaded thereon.

Optionally, system 200 can further include an input device, such as a stylus or pen, 270, which can activate the digital annotation feature of system 200. Alternatively, as will be apparent given the description herein, a finger or pencil could also be utilized to activate the digital annotation features. In addition, system 200 can include a sensor system, which can include ultrasound, IR laser, charge-coupled device (CCD) cameras, or other types of sensors 242. The sensors 242 are calibrated to track the movement of the stylus 270 on the surface of the screen 210. The stylus 270 similarly may include transmitters and/or sensors to aid in tracking and to coordinate timing or control signals with the embedded digital annotation program.

For example, a user can couple an electronic presentation to the system 200. The presentation, for example, can be a conventional meeting presentation, such as a PowerPoint presentation, available from Microsoft. The presentation can be sent to the projection device 220 through conventional video cables or the like. The projection device projects the presentation onto screen 210.

When the user wishes to annotate the presentation by making marks or other visible symbols on the screen 210, the user can walk up to the digital annotation system 200, pick up the digital pen 270 and touch the surface 210 with the pen 270 (or touch with a finger) to initiate the display of a menu 250 on the screen 210. The menu can provide prompts for several different operations, including the initiation of digital annotation, the capture of digital annotation on the board, and the electronic saving of the annotations or markings (e.g., to a data file such as a PDF, TIFF, or JPEG file). Captured images can be output via port 260, such as a USB 2.0 connection, to a memory stick or a PC. The digital annotation provided by system 200 can include underlining, highlighting, drawing, writing, erasing, selecting a color, and/or selecting a blank page.

In operation, the digital annotation software can be implemented as follows. First, the digital annotation software is embedded into a video processing board that includes a video processing chip and its associated memory. For example, the digital annotation software can be loaded onto flash memory resident in chip 232.

The digital annotation software also provides for displaying a menu onto screen 210. The menu image generated on board 230 is sent to the projection head 222 for display. As mentioned above, the digital annotation function can be initiated by touching a special pen or stylus, of even a finger on screen 210.

The menu can be used to prompt the user to select one or more of a series of operations that are performed through the use of the embedded software. For example, the menu 250 can prompt the user to start annotating, save annotation, and send annotation file to a peripheral device, such as via port 260. The digital annotation operations provided by the software can include underlining, highlighting, drawing, writing, erasing, selecting a color, and/or selecting a blank page.

As the digital annotation operation is initiated, the sensor system can detect and capture annotations made by a user. In addition, the sensor system can convert the annotations made by the user on screen 210 into a particular data file, such as a PDF file, a TIFF file, a JPEG file, or the like. The board 230 can include additional memory (either included as part of chip 232 or separate from chip 232) to receive a copy of the captured annotation file. The user can keep the stored data file in the system 200 or it can transfer the file to an external memory device coupled via port 260.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electro-mechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A video processing chip comprising a central processing unit configured to provide video processing and digital annotation.

2. A digital annotation system, comprising:
a projection screen;
a projection device; and
a video processing chip configured to provide video processing and digital annotation.

3. The digital annotation system of claim 2, wherein the video processing chip is embedded in the projection screen.

4. The digital annotation system of claim 2, wherein the video processing chip is embedded in the projection device.

5. The digital annotation system of claim 2, wherein the projection device is a front projection device.

6. The digital annotation system of claim 2, wherein the projection device is a rear projection device.

7. The digital annotation system of claim 2, further comprising an annotation input device.

8. The digital annotation system of claim 7, wherein the annotation input device is an annotation stylus.

9. The digital annotation system of claim 7, wherein the annotation input device is a finger.

10. The digital annotation system of claim 2, wherein the digital annotation comprises at least one of underlining, highlighting, drawing, writing, erasing, selecting a color, and selecting a blank page.

11. A method of providing digital annotation comprising:
embedding digital annotation software into a video processing board comprising a video processing chip and its associated memory, wherein the digital annotation software performs the following steps:
activating the digital annotation function;
providing a menu of digital annotation operations;
detecting the digital annotation made by a user;
capturing the digital annotation made by the user;
storing the digital annotation made by the user; and
copying the digital annotation to a memory device.

12. The method of claim 11, wherein the digital annotation operations include at least one of underlining, highlighting, drawing, writing, erasing, selecting a color, and selecting a blank page.
